(19) United States
(12) Patent Application Publication
(10) Pub. No.: US 2007/0118235 A1
(43) Pub. Date: May 24, 2007

(54) APPARATUS AND METHOD OF DISPLAYING MULTIPLE MENUS

(75) Inventors: Kuan-Hong Hsieh, Shenzhen (CN); Han-Che Wang, Shenzhen (CN); Xiao-Guang Li, Shenzhen (CN); Wen-Chuan Lian, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,385

(22) Filed: Aug. 3, 2006

(30) Foreign Application Priority Data
Sep. 23, 2005 (TW) 094133057

(51) Int. Cl. G05B 11/01

(52) U.S. Cl. 700/17

(57) ABSTRACT

A display method for enabling a display apparatus to display multiple menus is provided. The display apparatus includes a screen and a frame connecting to the screen, the screen having a menu region and the frame having a touch strip corresponding to the menu region. The method includes the steps of: moving menu options of a menu displayed in the menu region in response to a stroke operation on the touch strip; and performing a function associated with a desired menu option in response to a touch operation on the touch strip. A related display apparatus is also provided.

### TECHNICAL FIELD

The present invention relates to a display apparatus and methods therefor, and particularly to a display apparatus and methods of displaying multiple menus.

### GENERAL BACKGROUND

Generally, a display apparatus is a device to visually output information including texts and graphics on a screen. It is widely and increasingly used in electronic devices. A first conventional display apparatus includes a screen to display data (i.e., an image) thereon, and a frame to support the screen. The frame is further disposed a plurality of mechanical function buttons thereon to actuate any desired function. The more functions the display apparatus has, the more mechanical function buttons the frame is disposed thereon. Therefore, the frame should be designed as large as possible to hold the mechanical function buttons. As a result, a volume of the display apparatus as a whole becomes larger, and an overall appearance of the whole display apparatus looks untidy.

A second conventional display apparatus adopts a touch screen instead of mechanical buttons. The touch screen using graphical user interface (GUI) displays on the display screen thereof buttons, allowing a user to touch by finger or the like for making a selection. However, by directly touching the display screen, the touch screen thereupon is easily scratched or damaged.

Therefore, there is a need for an improved display apparatus and touch-based display method therefore that can overcome the above-mentioned problems.

### SUMMARY

In one aspect of the present invention, a touch-based display apparatus is provided. The display apparatus is capable of displaying multiple menus. The display apparatus includes a screen, a frame, and a processing unit. The screen has a menu region for displaying a menu therein. The menu further includes a plurality of menu options. The frame connects to the screen and has a touch strip thereof. The touch strip corresponds to the menu region, and allows a user to select a desired menu option to perform an associated function therewith. The processing unit is programmed for moving the menu options displayed in the menu region in response to a stroke operation on the touch strip, and performing the function associated with the desired menu option in response to a touch operation on the touch strip.

In another aspect of the present invention, a touch-based method enabling a display apparatus to display multiple menus is also provided, wherein the display apparatus has a screen and a frame connected to the screen, the screen having a menu region and the frame having a touch strip corresponding to the menu region. The method includes the steps of: (a) moving menu options of a menu displayed in the menu region in response to a stroke operation on the touch strip; and (b) performing a function associated with a desired menu option in response to a touch operation on the touch strip.

Other advantages and novel features will be drawn from the following detailed description with reference to the attached drawings, in which:

### BRIEF DESCRIPTION OF THE DRAWINGS

FIG. 1 is an exemplary schematic diagram of a touch-based display apparatus enabling to display multiple menus in accordance with a preferred embodiment of the present invention, the display apparatus including a screen and a frame, the frame including a touch strip thereof;

FIG. 2 is a block diagram representing a hardware infrastructure of a sensing signal processing circuit for a touch sensitive unit beneath the touch strips of FIG. 1 with the signal processing circuit connecting to a processing unit;

FIG. 3 (including FIGS. 3A-3D) illustrate a series of menus involving different menu options displayed in a menu region of the screen of FIG. 1 in accordance with a preferred embodiment of the present invention, the menu region corresponding to the touch strip of FIG. 1; and

FIG. 4 is a flowchart of a preferred touch-based method for enabling a display apparatus of FIG. 1 to display multiple menus in accordance with a preferred embodiment of the present invention.

### DETAILED DESCRIPTION OF THE EMBODIMENT

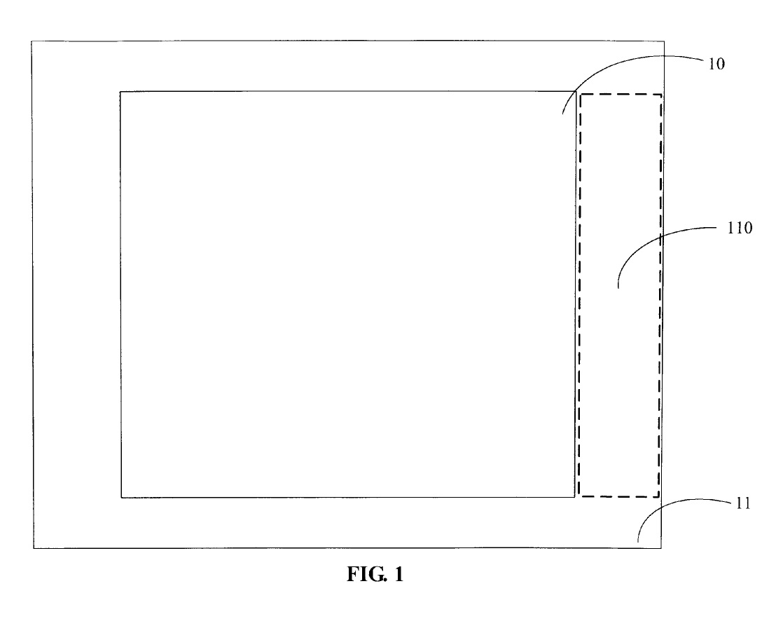

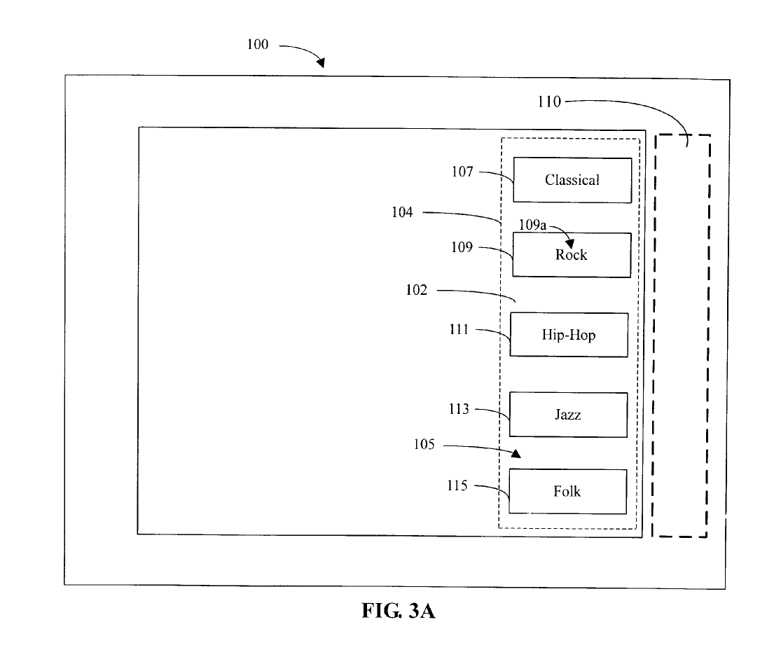

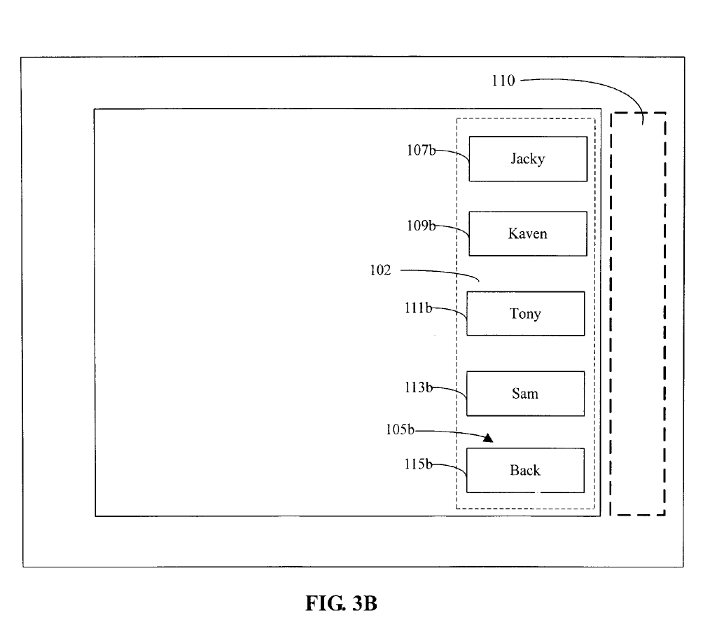

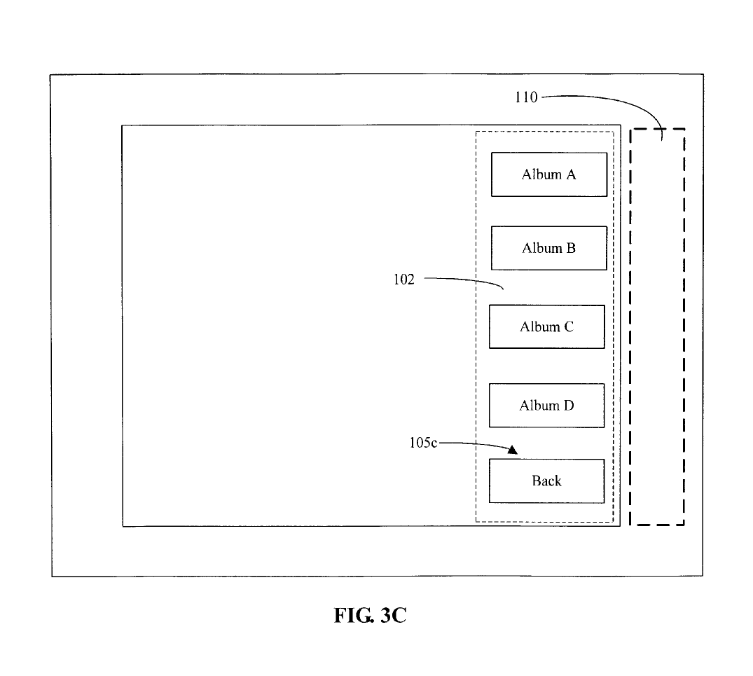

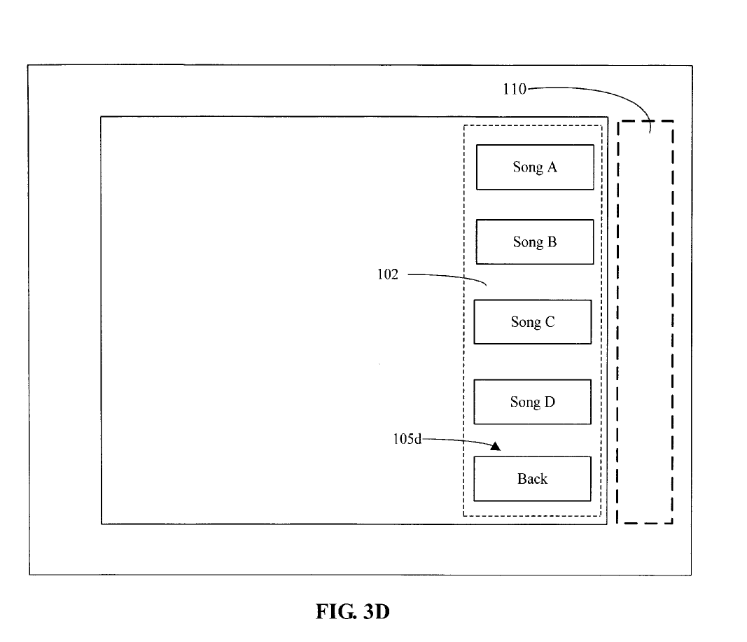

Referring to FIG. 1 and FIG. 3, a touch-based display apparatus 100 in accordance with a preferred embodiment of the present invention is shown. The display apparatus 100 includes a screen 10 and a frame 11. The screen 10 has a menu region 102 for displaying a menu 105 therein. The menu 105 has one or more menu options, at least some of which are displayed on the screen 10. One or more of the menu options may be hidden due to the limited space of the screen 10, but they are displayable on the screen 10.

Each menu option, as displayed, may be in a form of an icon, for example, icons 107, 109, 111, 113, and 115. Each icon may have a corresponding graphical label. For instance, icon 109 has a corresponding graphical label 109a. The corresponding graphical label can be a word, a symbol, a sign, a figure, a photo, a number, an indicator, or any combination of them. For example, in the embodiment as shown in FIG. 3A, the icon 109 has a corresponding graphical label 109a “Rock”.

Each icon can be in a form of a geometrical shape such as a square, a rectangle, a triangle, a circle, an ellipse, or any desired geometrical shape at a designer's choice. For example, in the embodiment as shown in FIG. 3A, the icon 109 is in the form of a rectangle. The icons can be same, shape-wise or size-wise, or different. For example, in the embodiment as shown in FIG. 3A, the menu options or icons have substantially same size.

Furthermore, the menu options or icons are arranged on the screen 10 to be within a contour line 104. The contour line 104 can be in the form of an open configuration or a closed configuration. For example, the contour line 104 can take a form of a rectangle, an ellipse, a circle, and son on. For the benefit of readers of this discourse and by way of example, in the embodiment as shown in FIG. 3A, the contour line 104 has the form of a rectangle. In addition, the contour line 104 can be visible or invisible to a viewer.

Corresponding to the menu region 102, the frame 11 provides a touch strip 110 thereon for being selectable by contact to perform a selected function associated with the menu options displayed in the menu region 102.

In one embodiment of the present invention, a first contact on the touch strip 110 initiates the menu 105 to be displayed in the menu region 102. After initiating the menu 105, a further contact on the menu strip 110 selects a desired menu option or icon of the menu options or icons displayed in the menu region 102. That is, when the desired menu option is in display, a touch on a corresponding location of the touch strip 110 performs a function associated with the menu option such as, for example, expanding a sub-menu of the menu option, executing a particular operation indicated by the menu option, etc; alternatively, when the desired menu option is not in display, a stroke on the touch strip 110 hides the currently displayed but now unselected menu options out of the menu region 102 until the selected or desired menu option rotates or moves into the menu region 102, and then an additional touch on the corresponding location of the touch strip 110 to perform the function associated therewith.

In order to provide a friendly and easy user interface, the touch strip 110 is designed to correspond to the menu region 102 parallel to the touch strip 110. Preferably, a length of the touch strip 110 is designed to correspond to a length of a side of the screen 10 displaying the menu region 102. Furthermore, the touch strip 110 has a plurality of touch sensitive units (not shown) beneath thereof. Each touch sensitive unit is constructed to essentially map to a menu option of the menu 105. That is, each touch sensitive unit is designed to perform a function associated with the menu option. Moreover, each touch sensitive unit includes a sensing signal processing circuit 112 (described in more detail below) for generating sensing signals to perform the function associated with the menu option in response to a contact on a corresponding location of the touch strip 110. Each touch sensitive unit beneath the touch strip 110 is further assigned a coordinate for identification.

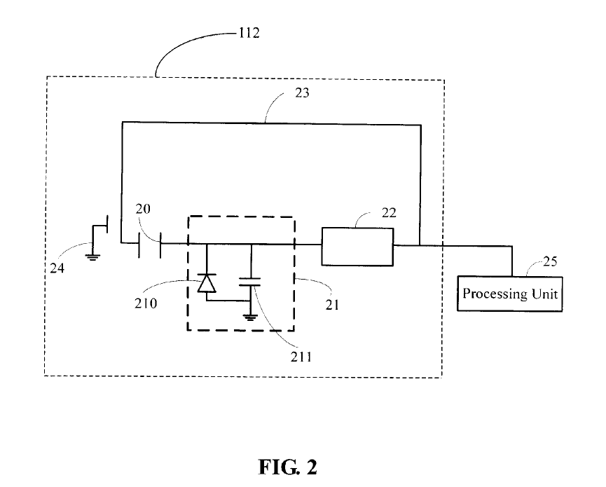

The display apparatus 100 further includes a processing unit 25 as shown in FIG. 2. Among other things, the processing unit 25 receives and processes the sensing signals from the touch sensitive units beneath the touch strip 110 according to the associated coordinates therewith, and performs corresponding functions. For example, in response to a single sensing signal from the touch strip 110, the processing unit 25 processes the sensing signal, initiates to display the menu 105 last displayed thereon in the menu region 102; in response to a plurality of sensing signals from the touch strip 110 while the corresponding menu 105 is in display, the processing unit 25 rotates or moves the menu options displayed in the menu region 102, that is, the processing unit 25 hides at least one of the menu options displayed in the menu region 102 and replaces the at least one of the displayed menu options by one of the hidden menu options; in response to a sensing signal from the touch strip 110, the processing unit 25 performs the function indicated by the selected menu option displayed in the menu region 102. In addition, when the selected menu option has a sub-menu, the processing unit 25 causes to displays a plurality of menu options of the sub-menu of the selected menu option, namely, icon 107b with a graphical label “Jacky”, icon 109b with a graphical label “Kaven”, icon 111b with a graphical label “Tony”, and icon 113b with a graphical label “Sam”, in the menu region 102, which are corresponding to the displayed selected menu option, i.e., icon with a graphical label “Rock”.

FIG. 2 shows a block diagram of a sensing signal processing circuit 112 for the touch sensitive unit beneath the touch strips of FIG. 1 according to one embodiment of the present invention, wherein the sensing signal processing circuit 112 is in communication with the processing unit 25. The sensing signal processing circuit 112 has an antenna 20, a clamping circuit 21, a detector 22, a feedback line 23, and a grounding line 24. The antenna 20 is electronically coupled to the clamping circuit 21 which itself is electronically coupled to an input end of the detector 22. An output end of the detector 22 is respectively electronically coupled to the processing unit 25 and one end of the feedback line 23. The feedback line 23 forms a positive feedback circuit with the antenna 21. The grounding line 24, which takes a form of a space between two adjacent touch sensitive units, is for spacing the touch sensitive units therebetween.

It is known that the human body is electrically charged with noise and static signals. Therefore, when a user contacts or touches the touch strip 110, at least some of the noise and static signals of the user with a desired signal may be received by the antenna 20. The antenna 20 transmits the received noise and static signals to the clamping circuit 21. However, the static electrical signals may cause interference to normal operation of the detector 22, and may even fry the detector 22. In addition, a strong noise may adversely influence a resulting sensing signal for the processing unit 25; that is, the sensitivity of the touch sensitive unit may be diminished, and the quality of the resulting sensing signal may be negatively impacted. Accordingly, the clamping circuit 21 is adapted for eliminating the static signals and for reducing the noise, thus improving the sensitivity accuracy of the touch sensitive unit.

The clamping circuit 21 in one embodiment of the present invention includes a diode 210, and a capacitor 211. The cathode of the diode 210 is electronically coupled to the antenna 20, while the anode is electronically coupled to ground. Upon receiving the noise and static signals with a desired signal, the diode 210 filters out the static signals to ground so as to avoid frying the detector 22, and reducing the noise influencing to the capacitor 211. The capacitor 211 further leaks a portion of the reduced noise to ground. Thus the reduced noise is further weakened, thereby obtaining a more accurate sensitivity.

The detector 22 has a high input impedance, so as to easily detect the desired signal with the reduced and weakened noise received from the input end of the detector 22. The detector 22 then converts the desired signal with the reduced and weakened noise into digital signals, namely the sensing signals, and transmits the sensing signals through the output end of the detector 22 to the processing unit 25 to perform corresponding controls. Furthermore, because the feedback line 23 forms a positive feedback circuit with the antenna 20, the noise generated as the user touches the edge of the touch sensitive unit is filtered, thereby further improving the sensitivity accuracy of the touch sensitive unit.

FIGS. 3A-3D illustrate a series of menus having different menu options that can be displayed in the menu region 102 of the screen 10 of the touch-based apparatus 100 as shown in FIG. 1 in accordance with a preferred embodiment of the present invention. In this exemplary embodiment, contents of the menu options provide desired information related to music, and only four menus are illustrated therein. However, either the content of the menu options or the number of the menus are not to be construed as being limited thereto.

Therefore, the menu region 102 displays different menus (namely different parts of the information) in different states. For example, referring to FIG. 3A, where namely a first display state of the screen 10 is shown, the menu region 102 displays a first menu 105 providing information related to music styles with menu options or icons having corresponding graphical labels “Classical”, “Rock”, “Hip-Hop”, “Jazz”, “Folk”, . . . , respectively.

Referring to FIG. 3B, where namely a second display state of the screen 10 is shown, the menu region 102 displays a second menu 105b, namely a sub-menu of a desired menu option of the first menu 105 such as, for example, menu option or icon with a graphical label “Rock”, the sub-menu 105b providing information related to rock music singers with menu options or icons having corresponding graphical labels “Jacky”, “Kaven”, “Tony”, “Sam”, . . . , respectively.

Referring to FIG. 3C, where namely a third display state of the screen 10 is shown, the menu region 102 displays a third menu 105c, namely a sub-menu of a desired menu option of the second menu 105b such as, for example, menu option or icon with a graphical label “Tony”, the sub-menu 105c providing information related to one rock music signer Tony's music albums with menu options or icons having corresponding graphical labels “Album A”, “Album B”, “Album C”, “Album D”, . . . , respectively.

Referring to FIG. 3D, where namely a fourth display state of the screen 10 is shown, the menu region 102 displays a fourth menu 105d, namely a sub-menu of a desired menu option of the third menu 105c such as, for example, menu option or icon with a graphical label “Album C”, the sub-menu 105d providing information related to specific music names in “Album C” with menu options or icons having corresponding graphical labels “Song A”, “Song B”, “Song C”, . . . , respectively.

Furthermore, the menus exclusive of the first menu 105 each have a “Back” menu option displayed in a constant location in the menu region 102 for easily returning to a former menu.

Accordingly, because touch strip 110 is used instead of function buttons for performing functions, the frame 11 can retain its neatness, regardless of how many functions the display apparatus 100 has. Furthermore, since the surface areas of the touch sensitive strip 110 can be designed in a smaller size, the frame 11 of the display apparatus 100 thereupon can be designed in a smaller size by using a narrow configuration, whereas the screen 10 thereof can be designed in a larger size, thereby the display apparatus 100 may not only obtain a neater appearance but may also posses a larger screen for display more information. Moreover, due to the utilization of the dynamic menus of the display apparatus 100, a user can easily select a desired menu option to perform the function associated therewith.

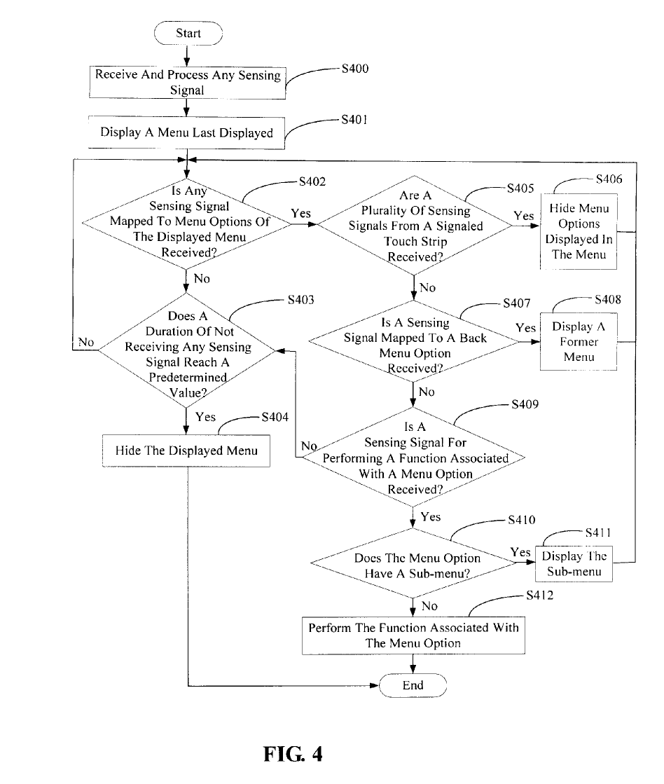

FIG. 4 is a flowchart of a preferred method for enabling a display apparatus 100 of FIG. 1 to display multiple menus in accordance with a preferred embodiment of the present invention. In step S400, the processing unit 25 receives and processes any sensing signal from the touch sensitive units beneath the touch strip 110. In step S401, the processing unit 25 acts to display the menu 105 last displayed thereon in the menu region 102. In step S402, the processing unit 25 determines whether it receives any sensing signal mapped to the menu options of the displayed menu 105.

If the processing unit 25 does not receive a sensing signal mapped to the menu options of the displayed menu 105, in step S403, the processing unit 25 determines whether the duration of not receiving any sensing signal from the touch strip 110 reaches a predetermined value. If the duration reaches the predetermined value, in step S404, the processing unit 25 hides the menu 105 displayed on the menu region 102, and the procedure is finished. If the duration does not reach the predetermined value, the procedure returns to step S402.

If the processing unit 25 receives a sensing signal mapped to the menu options of the displayed menu 105, in step S405, the processing unit 25 determines whether it further receives a plurality of sensing signals from the touch strip 110. If received, in step S406, the processing unit 25 moves the menu options displayed in the menu region 102, that is, the processing unit 25 hides at least one of the menu options displayed in the menu region 102 and replaces at least one of the displayed menu options by another hidden menu option, and the procedure returns to step S402. If not, in step S407, the processing unit 25 determines whether it receives the sensing signal mapped to the “Back” menu option. If received, in step S408, the processing unit 25 displays a former menu in the menu region 102, and the procedure returns to step S402. If not, in step S409, the processing unit 25 determines whether it receives the sensing signal for performing the function associated with the menu options except the “Back” menu option. If received, in step S410, the processing unit 25 determines whether the selected menu option has a sub-menu. If the selected menu option has a sub-menu, in step S411, the processing unit 25 displays a plurality of menu options of the sub-menu of the selected menu option in the menu region 102, and the procedure returns to step S402. If the selected menu option doesn't have a sub-menu, in step S412, the processing unit 25 performs the function associated with the menu option, and the procedure is finished.

Although the present invention has been specifically described on the basis of the preferred embodiment and preferred method thereof, the invention is not to be construed as being limited thereto. Various changes or modifications may be made to the embodiment and method without departing from the scope and spirit of the invention.

What is claimed is:

1. A display apparatus capable of displaying multiple menus, the display apparatus comprising:
a screen including a menu region for displaying a menu therein, wherein the menu comprises a plurality of menu options;
a frame connecting to the screen and having a touch strip thereof, the touch strip corresponding to the menu region and being selective to perform a function associated with a menu option displayed in the menu region; and
a processing unit being programmed for moving the menu options displayed in the menu region in response to a stroke operation on the touch strip, and performing the function associated with the desired menu option in response to a touch operation on the touch strip.

2. The apparatus according to claim 1, wherein each touch strip comprises a plurality of touch sensitive units each mapped to a menu option.

3. The apparatus according to claim 2, wherein each touch sensitive unit further comprises a sensing signal processing circuit for generating sensing signals in response to a contact, and each touch sensitive unit is designated a coordinate for identification.

4. The apparatus according to claim 3, wherein the processing unit acts to display menu options last displayed on the menu region in response to the contact on the touch strip.

5. The apparatus according to claim 4, wherein the processing unit acts to hide at least one of the menu options displayed in the menu region and replace the at least one of the displayed menu options by a hidden menu option in response to the stroke operation on the touch strip.

6. The apparatus according to claim 5, wherein the processing unit displays a plurality of menu options of a sub-menu of a selected menu option in response to the touch operation on the touch strip.

7. The apparatus according to claim 6, wherein the menu options of the sub-menu of the selected menu option comprise a particular menu option indicating a function of returning to a former menu.

8. The apparatus according to claim 7, wherein a location of the particular menu option is constant.

9. The apparatus according to claim 8, wherein a length of the touch strip correspond to a length of a side of the screen displaying the corresponding menu.

10. A method for enabling a display apparatus to display multiple menus, wherein the display apparatus has a screen and a frame connecting to the screen, the screen having a menu region and the frame having a touch strip corresponding to the menu region, the method comprising the steps of:
moving menu options of a menu displayed in the menu region in response to a stroke operation on the touch strip; and
performing a function associated with a desired menu option in response to a touch operation on the touch strip.

11. The method according to claim 10, further comprising the step of:
hiding the displayed menu options when a duration of not receiving any sensing signal from the touch strip reaches a predetermined value.

12. The method according to claim 11, wherein the moving step further comprises the step of:
hiding at least one of the menu options displayed in the menu region and replacing the at least one of the displayed menu options by a hidden menu option.

13. The method according to claim 12, wherein the performing step further comprises the step of:
displaying a sub-menu of the selected menu option if the selected menu option has the sub-menu.

14. The method according to claim 13, wherein the performing step further comprises the step of:
displaying a former menu when the selected menu option indicates a function of returning to the former menu.

15. The method according to claim 14, wherein a location of the menu option indicating the function of returning to the former menu is constant.
